(19) United States
(12) Patent Application Publication
(10) Pub. No.: US 2008/0087539 A1
(43) Pub. Date: Apr. 17, 2008

(54) Apparatus and Method for Materials Processing with Ion-Ion Plasma

(76) Inventors: Scott G. Walton, Burke, VA (US); Darrin Leonhardt, Gaithersburg, MD (US); Richard F. Fernsler, Annandale, VA (US)

Correspondence Address: US Naval Research Laboratory, 4555 Overlook Ave, SW, Washington, DC, 20375, US

(21) Appl. No.: 11/868,979

(22) Filed: Oct. 9, 2007

Related U.S. Application Data
(60) Provisional application No. 60/829,568, filed on Oct. 16, 2006.

(51) Int. Cl. H05F 3/00

(52) U.S. Cl. 204/164; 422/186.29

(57) ABSTRACT

A method and system for material processing employing extracting equivalent fluxes of positive and negative ions at two surfaces from an ion-ion plasma without substantially altering the plasma potential. The extraction is achieved by applying a continuously applied bias to the substrate being processed, in order to attract the ions to the substrate surface to facilitate materials processing such as etching, deposition and chemical modification at the surface. The continuously applied bias is applied via a power source coupled to the plate, also referred to as a stage or chuck, holding the substrate.

### CROSS-REFERENCE TO RELATED APPLICATIONS

The present application claims benefit under 35 U.S.C. § 119 (e) of a provisional U.S. patent application of Scott G Walton, Darrin Leonhardt, and Richard F Femsler, entitled “Apparatus and Method for Materials Processing with Ion-Ion Plasma”, filed Oct. 16, 2006, Ser. No. 60829568, the entire contents of said provisional application being incorporated herein by reference.

### BACKGROUND OF THE INVENTION

1. Field of the Invention

The present invention relates to materials processing. More specifically, the present invention relates to materials processing employing an ion-ion plasma, wherein a continuously applied bias is placed across the plasma.

2. Description of the Related Art

Plasmas are commonly used to modify materials and are an essential part of many advanced technologies, including the production of integrated circuits, nanomaterials, functional materials, and complex coatings. Most of the plasmas used in materials processing are discharges produced by applying an electric field to a gas volume. The electric field, whether DC or AC, must be large enough to heat the electrons so that some fraction of the total electron density is energetic enough to ionize the background gas. The ionization rate balances the electron loss rate from diffusion, attachment to neutrals, and ion-electron recombination. The electrons in these discharges are therefore hot when compared to the substrate, with temperatures (Tₑ) exceeding one electron volt (eV). Thus, these conventional processing plasmas are non-equilibrium plasmas where the ions and neutrals are near room temperature. Since the more energetic and light electrons move much faster than the cold (e.g., Tᵢ<<Tₑ), heavy ions, the plasma charges positive, until the electrostatic potential is sufficient for the electron and ion loss rates to equilibrate. This self-regulating behavior causes the formation of a “sheath” region located adjacent to the material, where the charge density is nonzero and strong fields exist. These fields not only reduce electron flow, they also increase the energy of positive ions leaving the plasma. Positive ions thus diffuse faster than their temperature would indicate. In addition to the behavior at the plasma boundary, the higher electron energy have has a strong influence on the diffusion of ions within the bulk plasma.

In electronegative gases such as oxygen or any halogen-based species, some electrons attach to the neutral gas molecules to form negative ions, which can exist in substantial quantities. The attachment rate varies with electron energy, and in halogen-based gases this rate increases with decreasing electron energy. However, any negative ions created in this manner are confined by the plasma potential and thus never reach the walls or substrates and are unable to etch, implant or participate in any other modification process a the surface.

By contrast, in ion-ion plasmas negative ions replace electrons as the dominant negative charge carrier. In most plasmas, the electron energy is too high to produce a negative ion density much larger than the electron density. Consequently, negative charge is still carried mainly by the hot (>1 eV) and mobile electrons. If however, the negative ion density is a few hundred (or more) times the electron density, the electron influence begins to wane and so the above description is no longer valid. In particular, when the plasma is comprised of two identical ion species of opposite charge and no electrons, the plasma potential falls to zero, positive and negative ions leave the plasma in equal numbers, and the flux of those species will diffuse from the plasma at the ion temperature, rather than the electron temperature.

Equal fluxes of both positive and negative ions would be useful for certain materials processing applications. In plasma-based microelectronic device fabrication, for example, the dissimilar response of electrons and ions leads to surface charging in high-aspect-ratio features. This charging can produce damaging effects such as oxide breakdown and local side etching (notching). It has been suggested that ion-ion plasmas reduce surface charging by delivering anisotropic fluxes of both positive and negative ions to substrate surfaces. In order to provide an anisotropic flux (e.g., forward velocity is much greater than transverse velocity) of energetic positive and negative ions, a continuously applied bias can be employed otherwise the plasma potential is negligible and the ion velocities are low at surfaces adjacent to ion-ion plasmas.

The commonly techniques used to deliver a flux of energetic ions to the surface of a material during processing have been developed for conventional electron-rich plasmas and largely depends on electrons being the dominant negative charge carrier, which is the case for commonly used plasmas. However, since electrons are not the dominant negative charge carrier in ion-ion plasmas, these techniques are not useful and the processing of materials with ion-ion plasmas requires a new approach. Thus a need exists for a system and method to deliver an alternating flux of both positive and negative ions to a substrate. This requires an approach which provides positive and negative ion fluxes that can be equivalent in magnitude and energy adjustable, depending on the process requirements.

### BRIEF SUMMARY OF THE INVENTION

The above described disadvantages are overcome and advantages realized by a materials processing method employing ion-ion plasma, wherein an alternating flux of positive and negative ions are delivered to the substrate material under process. This alternating flux is achieved by placing continuously applied bias between the substrate (located on one electrode) and another electrode. The voltage on the two electrodes is thus 180° out of phase with one another.

The invention provides a method and system for material processing including a stage disposed to receive a substrate of the material, the stage comprising a plurality of plates, the stage coupled to a signal source, said method comprising providing an ion-ion plasma, confining the ion-ion plasma between the plurality of plates via a magnetic field, applying a continuously applied bias to the substrate, the continuously applied bias operable to increase the energy of the ions at the surface of the substrate, processing the material by said applying the continuously applied bias.

### BRIEF DESCRIPTION OF THE DRAWINGS

The advantages and novel features of the present invention will be more readily appreciated from the following detailed description when read in conjunction with the accompanying drawings, in which:

FIG. 1 is an ion-ion plasma materials processing system constructed in accordance with an aspect of the present invention;

FIG. 2 is a schematic of chucks and biasing apparatus employed in an embodiment of the present invention;

FIG. 3 is a is a graph of the measured current from Ar/SF₆ plasma employing an embodiment of the present invention;

FIG. 4 is a graph of a more detailed view of the graph of FIG. 3.

FIG. 5 is a graph of measured current from Ar/SF₆ plasma employing an embodiment of the present invention where the center tap is not grounded.

FIG. 6 is a graph of measured current in an Ar/SF₆ plasma employing an embodiment of the present invention where the center tap is grounded.

### DETAILED DESCRIPTION OF THE INVENTION

The present invention describes a system and method for material processing employing extracting equivalent fluxes of positive and negative ions at two surfaces from an ion-ion plasma without substantially altering the plasma potential. The extraction is achieved by applying a continuously applied bias to the substrate being processed, in order to attract the ions to the substrate surface to facilitate materials processing, for example etching, deposition and chemical modification at the surface. The continuously applied bias is applied via a power source coupled to the chuck, also referred to as a stage or plate, holding the substrate. The present invention includes two symmetric electrodes upon which substrates are placed, located an equal distance from the ion-ion plasma center. An AC voltage signal can then be applied, through a transformer, across the two plates holding the substrates. One plate can be grounded, if needed.

The present invention employs an ion-ion plasma as the source for the positive and negative ions. An externally produced electron beam is used to ionize gas within the processing chamber, and the temperature of the plasma electrons thus produced is notably lower (<1 eV) than in other devices (for example, DC or AC electrical discharges). Due to the low temperatures, the conditions for ion-ion plasma formation are easily achieved in halogen-based gases like SF₆, making the extraction of alternating fluxes of both positive and negative ions possible. In all other plasma sources (DC discharges, RF discharges, helicons, electron-cyclotron reactors) ion-ion plasmas can generally be produced in the afterglow of a modulated plasma or far from the plasma source. While those schemes allow for positive and negative ion extraction, the flux is low and/or limited in duration, and thus these approaches have limited utility. Applications of the present invention include a variety of materials processing techniques including etching, deposition, implantation, and surface chemical modification. The present invention includes the ability to generate ion-ion plasmas in a continuous manner and facilitates the control of alternating fluxes of ions flowing to the substrate in terms of both intensity and energy.

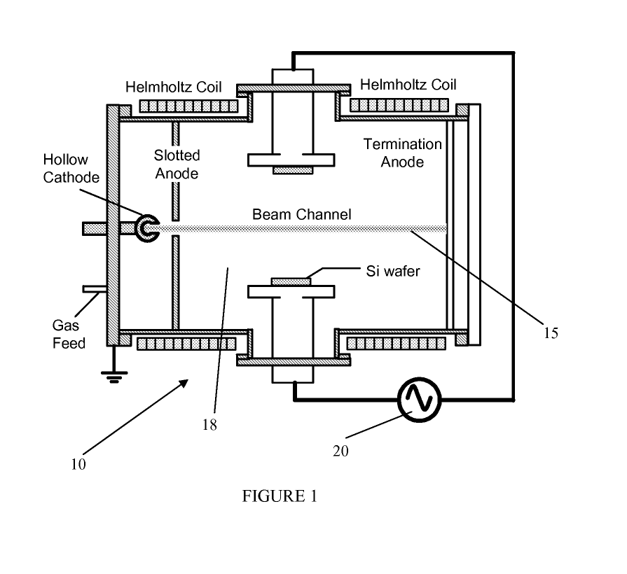

FIG. 1 illustrates one embodiment of the present invention including an ion-ion plasma material processing system 10. The an ion-ion plasma is generated using a magnetically confined, sheet electron beam 15 to ionize and dissociate a background gas containing a large concentration of a halogen-containing gas, e.g., >30%. The gas should have an attachment cross section exceeding 10⁻¹⁶ cm⁻² at electron energies below 0.5 eV. Gases that can be employed in the chamber 18 include SF₆, CCl₄, CCl₃F, Cl₂, F₂, or any gas that has a similar attachment cross section at similar electron energies. The beam energy is nominally a few keV or less, the beam current density is typically 0.1 A/cm² or less, the gas pressure is typically 100 mTorr or less, and the magnetic field along the beam is ≧100 G. The beam is nominally a few cm thick and arbitrarily wide, as determined by the chamber size and application. The magnetic field is applied to keep the beam thickness approximately constant over the beam range and to help confine plasma electrons. For the parameters specified, the beam range is 1 m or more, and the ion density produced exceeds 10⁹ cm⁻³. Thus, for a 1 m wide electron beam the system could generate dense, uniform, ion-ion plasmas over processing areas as large as 1 m² or more.

In operation, the ion-ion plasma material processing system 10 includes a beam 15 that collides with the halogen-containing gas molecules thereby generating ions, electrons, and radicals through ionization and dissociation. At the same time, gas flow keeps the gas cold, for example near room temperature, and the degree of ionization and dissociation low, for example around <20%. The plasma electrons therefore cool and attach to form negative ions, thereby producing a weakly, e.g., >1% ionized but dense (>10⁹ cm⁻³) plasma consisting mainly of positive and negative ions and neutral radicals. Note that, the plasma electrons are not actively heated by externally applied electric fields, so the ultimate temperature is much lower (for example Tₑ<0.5 eV) than in discharges (Tₑ>1 eV). Note too that the ionization region and rate are well-defined and controlled by the electron beam current and energy. By contrast ionization in discharges occurs throughout the chamber volume and at a rate determined by the plasma rate loss.

After the ions and radicals diffuse from the ionization region and leave the plasma, they etch any reactive material they contact. To facilitate the etch rate, the material or substrate 19 can be placed on a stage to which an AC voltage signal is applied at a frequency <1 MHz. The AC voltage delivered from a power source 20 increases both the ion energy (typically 5 eV or more) and the ion flux striking the material, up to the value determined by the beam current and energy. Gas breakdown which is possible if the AC voltage is too large at large, should be avoided. At low (<100 mTorr) gas pressure, the ion sheath is thinner than the ion mean free path, and thus isotropic radicals together with energetic and highly anisotropic, positive and negative ions strike the material. The etch rate can be increased by raising the beam current to increase the plasma and reactive radical densities, thereby increasing the reactive species flux to the substrate.

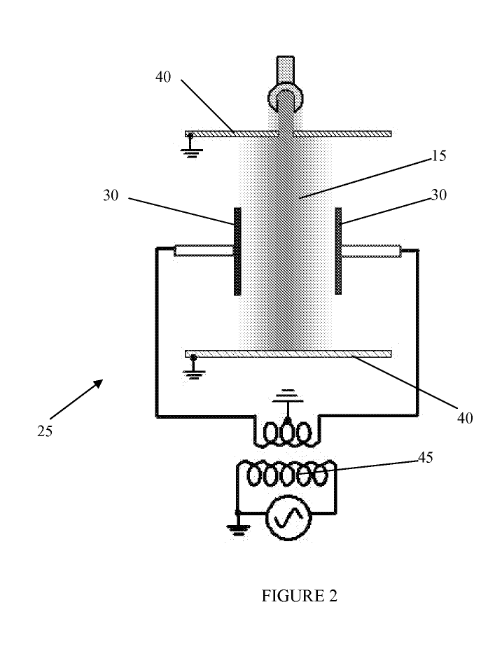

The plate configuration 25 is shown in FIG. 2. Although a plate is used in this instance, one of ordinary skill in the art would know that a plate can also be referred to as a chuck or stage. Here, two opposing plates 30 of identical surface area are positioned an equal distance from the beam center. In this configuration, the plasma potential at the physical center of the plasma is near ground, since the slotted and termination anodes 40 are grounded. Differences in plate (chuck or stage) areas or standoff distances can destroy this symmetry and thus drive ion current away from the plates and/or increase surface charging. The standoff distance should, in general, be less than the radius of the plate in order to keep the particle fluxes uniform across the plate.

The method of biasing the plates can be similar to flux optimization. The continuously applied bias is operable to increase the energy of the ions in the substrate material and to generate a substantially equivalent current of positive and negative ions at the surface of the substrate. The applied continuously applied bias can be in the form of a DC signal being applied to the plurality of plates.

The applied bias on each plate should be 180° out of phase, thus one plate is positively biased while the other plate is negatively biased. Applying the continuously applied bias out of phase is easily achieved if the AC signal is applied through a transformer 45 rather than a standard match box. The use of the transformer 45 has additional benefits as well, including the ability to evenly divide either the voltage amplitude or current amplitude by grounding or floating the center tap on the transformer secondary. Grounding the center tap ensures equivalent voltages amplitudes on either plate. Conversely, if the center tap of the transformer secondary is left floating, each plate will receive the same flux of positive and negative ions during opposite voltage swings, independent of relative plate areas or standoffs. That is, the plasma will self adjust until the current is the same at each plate. Note, however, when the center tap is floating, the voltages may not be equivalent.

The positive and negative ion fluxes reaching each plate will be approximately 180° out of phase if the AC signal is applied through an isolation transformer 45 rather than a standard match box. However, the ion energies will in general differ, because of differences in the mass and mobility of the positive and negative ions. If instead, the center tap on the transformer is grounded, the voltage amplitudes are about the same, but the positive and negative ion fluxes will differ.

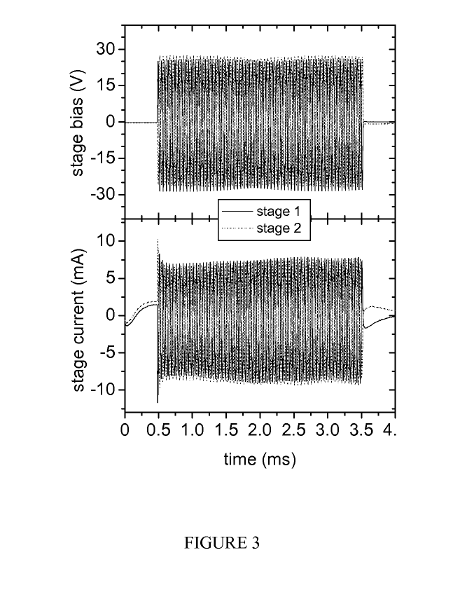

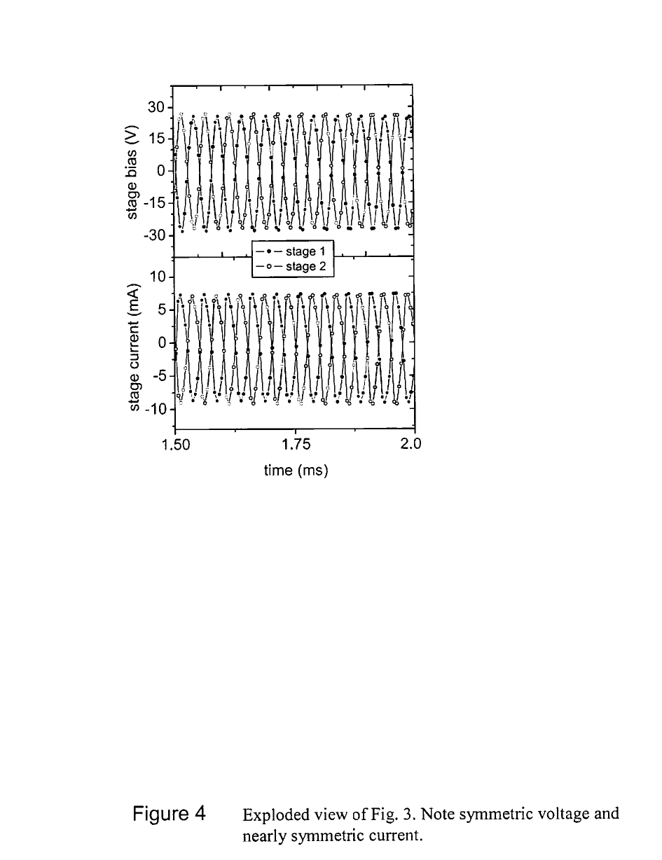

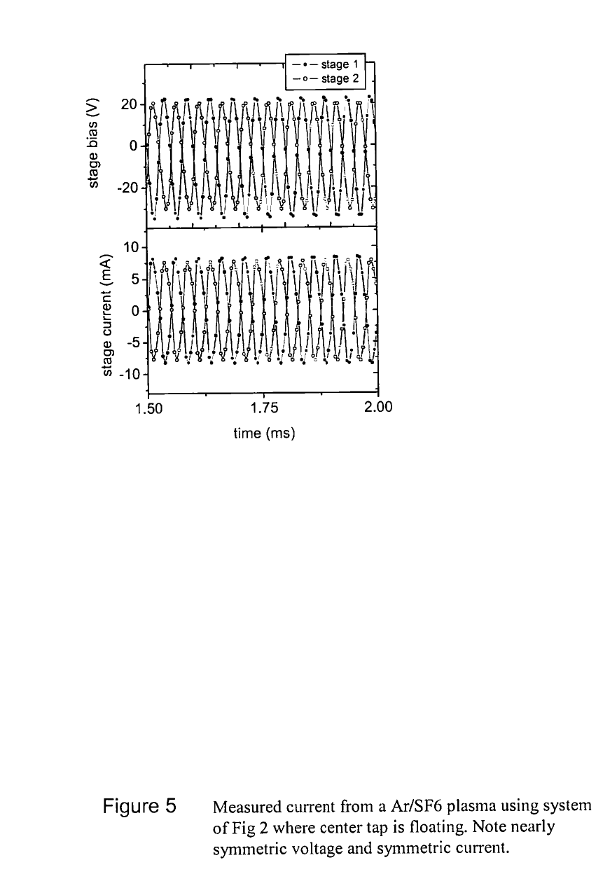

This is illustrated in FIGS. 3-6, where the current and voltage is measured at each electrode as a function of time. The current and voltage magnitudes are nearly symmetrical, about zero, whether the center tap is grounded or not. Specifically, FIG. 3 illustrates measured current from a Ar/SF₆ plasma using the system of FIGS. 1 and 2 where the center tap is grounded. The plate's continuously applied bias can be applied during the last 3 ms of a 3.5 ms plasma operated at a 10% duty. The voltage and current are nearly identical and symmetric for each plate. FIG. 4 is illustrative of a more detailed view of FIG. 3. FIG. 5 is illustrative of the measured current from a Ar/SF₆ plasma system employing the present invention, where the center tap is floating or not grounded. It should be noted that the voltage and current are essentially symmetric in this case, irrespective of the center tap.

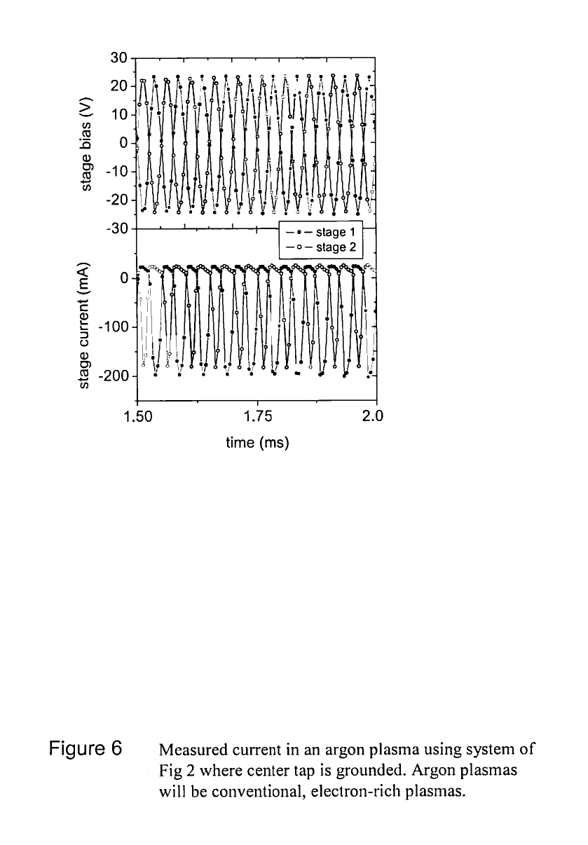

Such behavior is possible in ion-ion plasmas. By contrast, either the voltage or current is asymmetrical in electron rich plasmas, such as the argon plasma employing the system of FIG. 2, as indicated in FIG. 6 taken in a pure electropositive gas (argon). Note in particular that the current is now highly asymmetrical when the center tap of the secondary is grounded, because of the presence of a large electron current. Argon plasmas are considered conventional type plasmas and are not ion-ion plasmas. Accordingly, FIG. 6 is an example of an electron rich plasma and thus does not behave as indicated in the previous Figures.

Although only several exemplary embodiments have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A method for material processing including a substrate of the material, the substrate disposed on at least one of a plurality of plates, the plates coupled to a signal source, said method comprising:
providing an ion-ion plasma;
confining the ion-ion plasma between the plurality of plates via a magnetic field;
applying a continuously applied bias to the substrate, the continuously applied bias operable to increase an ion energy of the ions in the substrate;
processing the material by said applying the continuously applied bias.

2. A method as claimed in claim 1, wherein said applying a continuously applied bias includes applying a continuously applied bias of 180° out of phase by applying an AC voltage signal with a frequency less than 1 MHz via a transformer.

3. A method as claimed in claim 1, wherein said applying a continuously applied bias includes applying an AC voltage signal.

4. A method as claimed in claim 1, wherein said applying a continuously applied bias includes applying an AC voltage signal with a frequency greater than 1 kHz, via a transformer.

5. A method as claimed in claim 1, wherein said processing includes etching, deposition, implantation, and chemical modification at the surface of the substrate.

6. A method as claimed in claim 2, wherein the AC voltage signal includes a substantially equivalent voltage applied to the plurality of plates, the AC signal operable to increase ion energy and ion flux striking the substrate.

7. A method as claimed in claim 6, wherein the ion energy is greater than approximately 5 eV.

8. A method as claimed in claim 1, wherein the one of a plurality of plates is electrically grounded.

9. A method as claimed in claim 1, wherein said applying a continuously applied bias to the substrate, the continuously applied bias operable to increase an ion energy of the ions in the material by generating a substantially equivalent current of positive and negative ions at a surface of the substrate.

10. A method as claimed in claim 1, wherein said applying a continuously applied bias includes applying a DC signal to the plurality of plates.

11. A method as claimed in claim 1, wherein the one of a plurality of plates is negatively continuously applied biased and the other is positively continuously applied biased.

12. A method as claimed in claim 1, wherein the plurality of plates are substantially equidistant from the center of the ion-ion plasma.

13. A method as claimed in claim 1, wherein the plurality of plates include faces of an substantially equal area.

14. A method as claimed in claim 13, wherein the electrical grounding includes grounding a center tap of the signal source.

15. A method as claimed in claim 13, wherein the signal source includes a transformer.

16. A system for materials processing including a stage comprising a plurality of plates, said system comprising:
an ion-ion plasma operable to be confined between the plurality of plates via a magnetic field;
a power source; and
a substrate of a material to be processed by applying a continuously applied bias to the substrate via said power source, and applying an electrical ground to the one of the plurality of plates, the continuously applied bias operable to increase ion energy of the ions in the material by generating an substantially equivalent current of positive and negative ions at a surface of the substrate, and employing the ions to process said substrate.

17. A system as claimed in claim 16, wherein the processing of said substrate includes etching, deposition, implantation, and chemical modification at the surface of the substrate.
